(19) United States
(12) Patent Application Publication
(10) Pub. No.: US 2026/0355969 A1
(43) Pub. Date: Nov. 12, 2026

(54) OPERATING A ROBOT HAVING A GRIPPER

(71) Applicant: KUKA Deutschland GmbH, Augsburg (DE)

(72) Inventors: Dominik Joho, Augsburg (DE); Kirill Safronov, Aindling (DE); Yunus Ayar, Augsburg (DE)

(73) Assignee: KUKA Deutschland GmbH, Augsburg (DE)

(21) Appl. No.: 19/131,424

(22) PCT Filed: Nov. 15, 2023
(86) PCT No.: PCT/EP2023/081830

§ 371 Date: May 20, 2025

(30) Foreign Application Priority Data
Dec. 13, 2022 (DE) 10 2022 213 555.5
Dec. 13, 2022 (DE) 10 2022 213 557.1
Dec. 13, 2022 (DE) 10 2022 213 562.8
Dec. 13, 2022 (DE) 10 2022 213 568.7

(51) Int. Cl. B25J 9/16

(52) U.S. Cl. CPC B25J 9/1697; B25J 9/1669

(57) ABSTRACT

A method for operating a robot that guides a gripper includes determining a pose of the gripper on the basis of a position of the robot, determining at least one virtual boundary contour in an image of at least part of the gripper in the surroundings of the gripper on the basis of the determined pose, classifying data of the image on the basis of the determined at least one boundary contour, determining a pose of a load held by the gripper on the basis of the classified data, and controlling the robot and/or the gripper on the basis of the determined pose of the load.

### CROSS-REFERENCE TO RELATED APPLICATIONS

This application is a national phase application under 35 U.S.C. § 371 of International Patent Application No. PCT/EP2023/081830, filed Nov. 15, 2023 (pending), which claims the benefit of priority to German Patent Application Nos. DE 10 2022 213 555.5, DE 10 2022 213 557.1, DE 10 2022 213 562.8, and DE 10 2022 213 568.7, each filed Dec. 13, 2022, the disclosures of which are incorporated by reference herein in their entirety.

### TECHNICAL FIELD

The present invention relates to a method and system for operating a robot which guides a gripper, as well as to a computer program or computer program product for carrying out a method described herein.

### SUMMARY

The object of the present invention is to improve the operation of a robot which guides a gripper.

This object is achieved by a method, a system, and a computer program or computer program product, respectively, for carrying out a method as described herein.

According to one embodiment of the present invention, a robot has a robot arm, in particular can be such. Additionally or alternatively, the robot, in particular the robot arm, in one embodiment has at least three, in particular at least six, in one embodiment at least seven, joints or (movement) axes, in a development at least three, in particular at least six, in one embodiment at least seven, rotary joints or rotary axes.

According to one embodiment of the present invention, the robot guides or carries a gripper, in a development a finger gripper with one or more adjustable fingers, a suction gripper, a magnetic, preferably electromagnetic, gripper or the like. In one embodiment, the gripper is arranged on the robot, in particular the robot arm, preferably on an end flange of the robot, in particular the robot arm, preferably in such a manner that it is non-destructively removable or replaceable.

According to one embodiment of the present invention, a method for operating the robot that guides the gripper comprises the step of determining a pose of the gripper based on a position of the robot.

A pose comprises in one embodiment a one-, two-or three-dimensional position and/or a one-, two-or three-dimensional orientation, a pose of the gripper determined on the basis of a position of the robot in one embodiment a one-, two-or three-dimensional position and/or a one-, two-or three-dimensional orientation of the gripper relative to a robot-fixed reference system, in one embodiment relative to a base of the robot, in particular the robot arm, and/or relative to surroundings of the robot, a pose of a load held by the gripper determined here in one embodiment a one-, two- or three-dimensional position and/or a one-, two- or three-dimensional orientation of the load relative to the gripper, relative to a robot-fixed reference system, in one embodiment relative to a base of the robot, in particular the robot arm, or relative to surroundings of the robot. In one embodiment, a position of the robot comprises the positions of the joints or axes of the robot, preferably detected or actual positions and/or commanded or desired positions of the joints or axes of the robot. Thus, a pose of the gripper can be determined in one embodiment using forward kinematics or transformation based on the position(s of the joints) of the robot.

According to one embodiment of the present invention, the method comprises the further step of: determining one or more virtual boundary contours in an image of at least part of the gripper in or with surroundings of the gripper (in each case) on the basis of the determined pose of the gripper, the or one or more of the boundary contour(s) in each case preferably having the pose of the gripper or a predetermined translational and/or rotational offset with respect to the pose of the gripper. In one embodiment, the method also includes the step of determining this image; in another embodiment, the determined image can also be provided by an external instance.

In one embodiment, the image comprises a three-dimensional point cloud and/or a camera image and/or is determined with the aid of a 3D recording device, in particular at least one 3D camera, at least two spatially spaced stereographic cameras, at least one 3D scanner or the like. In one embodiment, data of the image indicate three-dimensional positions of points of the gripper or its surroundings, preferably of points of the surface of the gripper or its surroundings.

According to one embodiment of the present invention, the method comprises the further steps of:
classifying, preferably (reducing by) sorting out or eliminating or filtering (out), data of the image on the basis of the determined boundary contour, in particular on the basis of the determined boundary contours;
determining a pose of a load held by the gripper on the basis of the (thus) classified, in particular reduced, data; and
controlling the robot and/or gripper based on this determined pose of the load.

One embodiment of the present invention is based on the realization that a pose of the robot-guided gripper can be determined based on a known position of the robot, and the concept based thereon of exploiting this to better, in particular (more) quickly and/or (more) precisely, determine a pose of a load held by the gripper based on an image of the gripper with the load in or with its surroundings, preferably by at least some of the data of the image being first sorted out or filtered out as not being assigned to the load based on a pose of the gripper, and the pose of the load is then determined only on the basis of the (data of the) image reduced in this way.

In one embodiment, the or one of the virtual boundary contour(s) determined on the basis of the determined pose of the gripper is a gripper boundary contour for the gripper in the image, which is determined on the basis of a data model of the gripper, and the classification of data comprises sorting out or eliminating or filtering (out) data of the image assigned to the gripper on the basis of this gripper boundary contour, in particular data which or whose position lies within the gripper boundary contour.

The data model of the gripper is determined in one embodiment on the basis of design data, in particular CAD data, of the gripper, or may include such data. In one embodiment, the gripper boundary contour for the gripper corresponds to a, preferably simplified, (virtual) representation of the gripper in the image and/or is determined in one embodiment in such a way that, within the scope of a tolerance caused by the simplification, it at least partially corresponds to an outer contour of the gripper, in particular a theoretical one or one based on the data model, and preferably lies within the actual outer contour. In one embodiment, the gripper boundary contour changes accordingly as a result of a change in the position of the gripper, for example of one or more fingers of the gripper, or the gripper boundary contour for the gripper in the image is (also) determined on the basis of a commanded or detected pose of members of the gripper relative to one another (gripper position).

This is based on the realization that (more) precise data models are often available for the gripper, and the idea of exploiting the fact that the pose of the outer contour of the gripper in the image is determined relatively precisely on the basis of its determined pose and such a data model or a virtual boundary contour determined on the basis thereof and, based on this, the data of the image assigned to the gripper are sorted out (more) quickly, (more) precisely and/or (more) reliably. As a result, the determination of the pose of the load based on the (correspondingly reduced) data of the image can be carried out better, in particular (more) quickly, (more) precisely and/or (more) reliably.

Additionally or alternatively, in one embodiment, the or a (further) virtual boundary contour(s) determined on the basis of the determined pose of the gripper is a surrounding boundary contour for surroundings of the gripper in the image, which is determined on the basis of dimensions, in particular theoretical or target dimensions or real or recorded dimensions, of the gripper and/or dimensions, in particular theoretical or target dimensions or real or recorded dimensions, of a load held by the gripper, preferably the load whose pose is determined, and the classification of data comprises sorting out or eliminating or filtering (out) data of the image assigned to surroundings of the gripper (which in one embodiment comprises the robot and/or (common) surroundings of gripper and robot, i.e., in particular a background of or objects different from the gripper, the robot (and the load)) on the basis of this surrounding boundary contour, in particular data which or whose position is outside the surrounding boundary contour.

In one embodiment, the surrounding boundary contour for surroundings of the gripper has a virtual, preferably convex, envelope around the load, in a preferred embodiment in the form of an ellipsoid, in particular a sphere, or a cuboid, and/or is determined such that the load lies completely within the surrounding boundary contour.

This is based on the realization that the approximate pose of the load relative to its surroundings is already known from the pose of the gripper, and on the idea that by masking out data from the image that lie outside a boundary contour that is located at or near the determined pose of the gripper and thus also at or near the pose of the load it is holding and is dimensioned so that it reliably envelops the load or with a corresponding safety margin, data from the image that reliably do not belong to the load can be sorted out (more) quickly, (more) precisely and/or (more) reliably, and as a result the determination of the pose of the load based on the (correspondingly reduced) data from the image can be carried out better, in particular (more) quickly, (more) precisely and/or (more) reliably.

In one embodiment, the classification of data of the image on the basis of the determined gripper boundary contour and surrounding boundary contour is carried out in several stages, by first reducing image data by sorting them out on the basis of the surrounding boundary contour and then (even) further reducing these reduced data by sorting them out on the basis of the gripper boundary contour. In one embodiment, this has the advantage that a significant data reduction can often be achieved by sorting based on the surrounding boundary contour. In addition, in one embodiment, the surrounding boundary contour can have a simple(r) geometric shape (than the gripper boundary contour), so that the corresponding sorting can be carried out (more) quickly, (more) precisely and/or (more) reliably and thus the subsequent sorting based on the gripper boundary contour can also be improved.

In another embodiment, the classification of image data is carried out on the basis of the determined gripper boundary contour and surrounding boundary contour by, conversely, first reducing image data by sorting based on the gripper boundary contour and then (even) further reducing these reduced data by sorting based on the surrounding boundary contour.

In another embodiment, the classification of data of the image on the basis of the determined gripper boundary contour and surrounding boundary contour takes place in parallel, in a development by sorting out in one step both data which or whose position lies outside the surrounding boundary contour and data which or whose position lies within the gripper boundary contour. This can speed up the method.

In one embodiment, the data reduced by sorting based on the gripper boundary contour and/or based on the surrounding boundary contour, which data substantially contain data assigned to the load, are (further or post-) filtered before or for determining the pose of the load. In one embodiment, this allows the pose to be determined even better, in particular (more) quickly, (more) precisely and/or (more) reliably.

Additionally or alternatively, in one embodiment, the data reduced by sorting based on the gripper boundary contour and/or based on the surrounding boundary contour, which data substantially contain data assigned to the load, are converted into a depth image, if necessary after further data processing, for example the aforementioned post-filtering, and based on this, a mask is determined (in each case) which can be advantageously used to segment the load in one or more 2D images. In one embodiment, the pose of the load is determined based on this segmentation on the basis of the classified or reduced data of the image. In one embodiment, this allows the segmentation of the load in a 2D image or the determination of the pose to be improved, in particular to be carried out (more) quickly, (more) precisely and/or (more) reliably. In one embodiment, by segmenting the load based on the mask(s), which in turn are determined based on the classified data, the pose of the load held by the gripper is determined (also) based on the classified data.

In one embodiment, controlling the robot and/or gripper based on the determined pose of the load comprises transporting and/or releasing the load with the robot-guided gripper.

In a particularly advantageous application, controlling the robot and/or gripper on the basis of the determined pose of the load comprises monitoring and/or correcting a pose of the load, particularly preferably during gripping, transporting and/or releasing the load with the robot-guided gripper. In this case, in one embodiment, the pose of the load, preferably relative to the gripper, is checked once or several times or compared with a reference pose, preferably while the robot is transporting the load. If, in this case, an incorrect pose or an undesirable change in the pose of the load is determined or detected, this is responded to in one embodiment by issuing a corresponding warning and/or a corresponding (control of a) movement of the robot and/or gripper, for example adjusting the handle, setting down and re-picking up the load, adjusting the position of the robot for or when releasing the load or the like.

According to one embodiment of the present invention, a system, in particular in terms of hardware and/or software, in particular in terms of programming, is configured to carry out a method described herein and/or comprises:
means for determining a pose of the gripper based on a position of the robot;
means for determining one or more virtual boundary contours in an image of at least part of the gripper in surroundings of the gripper based on the determined pose, in one embodiment for determining the gripper boundary contour based on the determined pose and a data model of the gripper and/or for determining the surrounding boundary contour based on the determined pose of the gripper and dimensions of the gripper and/or a load held by the gripper;
means for classifying data of the image on the basis of the determined at least one boundary contour, in particular for sorting out data of the image assigned to the gripper on the basis of the gripper boundary contour and/or for sorting out data assigned to surroundings of the gripper, in particular the robot and/or surroundings of the gripper and robot, on the basis of the surrounding boundary contour;
means for determining a pose of a load held by the gripper based on the classified data; and
means for controlling the robot and/or gripper based on the determined pose of the load.

In one embodiment, the system or its means comprises: means for converting the data of the image reduced by sorting based on the gripper boundary contour and based on the surrounding boundary contour into a depth image, means for determining at least one mask based on this depth image, and means for segmenting the load in a 2D image based on this mask.

A system and/or a means within the meaning of the present invention may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus is in particular able to control the robot and/or the gripper.

In one embodiment, a computer program product may comprise, in particular be, an, in particular computer-readable and/or non-volatile, storage medium for storing a program or instructions or with a program stored thereon or with instructions stored thereon. In one embodiment, execution of said program or said instructions by a system or controller, in particular a computer or an arrangement of multiple computers, causes the system or controller, in particular the computer(s), to carry out a method described herein or one or more steps thereof, or the program or instructions are configured to do so.

In one embodiment, one or more, in particular all, steps of the method are fully or partially computer-implemented or one or more, in particular all, steps of the method are fully or partially automated, in particular by the system or its means.

In one embodiment, the system comprises the robot and/or gripper.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts an exemplary system for operating a robot, which guides a gripper, according to one embodiment of the present invention; and

FIG. 2 depicts a method for operating the robot according to one embodiment of the present invention.

### DETAILED DESCRIPTION

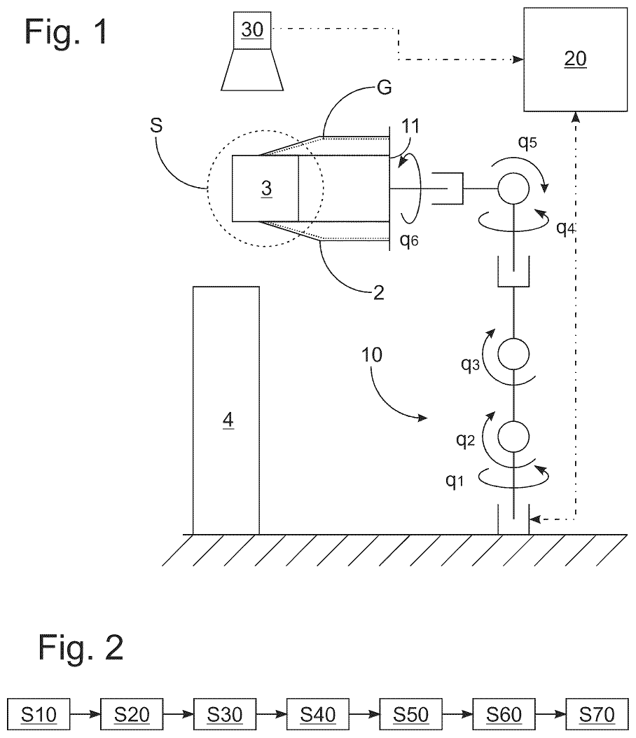

FIG. 1 shows an exemplary system for operating a six-axis robot 10, whose (joint) position(s) are specified by joint coordinates q₁, . . . , q₆ and on whose end flange 11 a gripper 2 with a load 3 held by it is arranged. A robot controller 20 communicates with the robot 10 and a recording device 30 for recording an image of at least part of the gripper 2 in its surroundings.
In a step S10, the image is provided in the form of a point cloud and based on the (joint) position(s) q=[q₁, . . . , q₆] of the robot 10 a pose x of the gripper 2 is determined, which indicates its three-dimensional position and three-dimensional orientation relative to the surroundings (x=x(q)).
In a step S20, based on the known dimensions of the load 3 and the pose of the gripper 2 determined in step S10, a diameter and a (center) position of a sphere S are determined such that the held load 3 can be arranged completely within the sphere with a predetermined tolerance. For example, the position of the gripper determined by the pose of the gripper plus a target offset between the gripper base and the load center can be determined as the position [x, y, z] of the center of the sphere S, and the diameter of the sphere S can be chosen to be large enough that the load (still) lies completely within the sphere S even with the maximum possible deviation from this target offset (with the load (still) held). Preferably, the position of the gripper itself, determined by the pose of the gripper, can be determined as the position [x, y, z] of the center of the sphere S, and the diameter of the sphere S can be chosen to be correspondingly larger, so that the held load always lies completely within the sphere S.
Now, in a step S30, those data of the image that lie outside the sphere S are sorted out or eliminated, for example data assigned to a storage 4. This corresponds to a sorting out of data assigned to the surroundings of the gripper, in particular the robot 10 and a common surroundings 4 of the gripper and robot, on the basis of a surrounding boundary contour in the form of the sphere S.
In a step S40, based on a data model of the gripper 2 and the pose of the gripper 2 determined in step S10, a gripper boundary contour G for the gripper 2 in the image is determined, which lies slightly within the outer contour of the gripper 2 in the pose determined in step S10.
Then, in a step S50, those of the image data remaining after step S30 that lie within the gripper boundary contour G are eliminated. This corresponds to a sorting out of data assigned to the gripper 2 on the basis of the gripper boundary contour G determined in step S40.

By this sorting, first on the basis of the surrounding boundary contour (step S30) and then on the basis of the gripper boundary contour (step S50), the remaining data of the image are classified as data potentially assigned to the load 3.
Now, in a step S60, the pose of the load 3 relative to the gripper 2 is determined on the basis of the data classified in this way, in a manner known per se, for example by recognizing or matching patterns or the like. In one embodiment, in step S60 the image data reduced by sorting based on the gripper boundary contour and based on the surrounding boundary contour are converted into a depth image, preferably after post-filtering, one or more masks are determined based thereon, and these are (each) used to segment out the load in a 2D image, this segmentation or segmented 2D image(s) being able to be used in particular to determine the pose.
In a step S70, the robot 10 and/or gripper 2 is controlled on the basis of the pose of the load 3 determined in this way, in particular during transport of the load 3, its pose relative to the gripper 2 is compared or checked with a reference pose and, in the event of an inadmissible deviation, for example slipping, is corrected accordingly.

By using the pose of the gripper 2 determined in step S10, the elimination of image data assigned to the gripper or the surroundings can be improved, in particular carried out (more) quickly.

In addition, this can advantageously reduce errors in determining the pose of the load, which are based on parts of the gripper or the surroundings being mistaken for parts of the load.

Furthermore, since the pose of the load is already approximately known due to the pose of the gripper 2 determined in step S10, the determination of the actual pose of the load 3 on the basis of the (classified or reduced data of the) image can be improved, in particular carried out (more) quickly.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

2 gripper
3 load
4 storage
10 robot
11 end flange
20 robot controller
30 recording device
G gripper boundary contour
S sphere (surrounding boundary contour)
q₁-q₆ (joint) position(s) of the robot

What is claimed is:

1. Method for operating a robot (10) which guides a gripper (2), comprising the steps of:
determining (S10) a pose of the gripper on the basis of a position of the robot;
determining (S20; S40) at least one virtual boundary contour (S; G) in an image of at least part of the gripper in the surroundings of the gripper on the basis of the determined pose;
classifying (S30; S50) data of the image on the basis of the determined at least one boundary contour;
determining (S60) a pose of a load (3), held by the gripper, on the basis of the classified data; and
controlling (S70) the robot and/or the gripper on the basis of the determined pose of the load.

2-8. (canceled)

9. Method according to claim 1, characterized in that a virtual boundary contour determined on the basis of the determined pose of the gripper is a gripper boundary contour for the gripper in the image determined on the basis of a data model of the gripper, and the classification of data comprises sorting out data of the image assigned to the gripper on the basis of this gripper boundary contour.

10. Method according to claim 1, characterized in that a virtual boundary contour determined on the basis of the determined pose of the gripper is a surrounding boundary contour for surroundings of the gripper in the image determined on the basis of dimensions of the gripper and/or a load held by the gripper, and the classification of data comprises sorting out data of the image assigned to surroundings of the gripper, in particular the robot and/or surroundings of the gripper and robot, on the basis of this surrounding boundary contour.

11. Method according to 9, characterized in that, first, data of the image are reduced by sorting on the basis of the surrounding boundary contour and then the reduced data are further reduced by sorting on the basis of the gripper boundary contour.

12. Method according to claim 9, characterized in that the data of the image reduced by sorting on the basis of the gripper boundary contour and/or on the basis of the surrounding boundary contour are converted into a depth image and, based thereon, at least one mask is determined, in particular for segmenting the load in a 2D image.

13. Method according to claim 1, characterized in that the control of the robot and/or gripper on the basis of the determined pose of the load comprises transporting and/or releasing the load with the robot-guided gripper and/or monitoring and/or correcting a pose of the load, in particular during gripping, transporting and/or releasing the load with the robot-guided gripper.

14. System for operating a robot which guides a gripper, wherein the system is set up to carry out a method according to claim 1 and/or comprises:
means for determining a pose of the gripper based on a position of the robot;
means for determining at least one virtual boundary contour in an image of at least part of the gripper in surroundings of the gripper on the basis of the determined pose;
means for classifying data of the image on the basis of the determined at least one boundary contour;
means for determining a pose of a load, held by the gripper, on the basis of the classified data; and
means for controlling the robot and/or gripper on the basis of the determined pose of the load.

15. Computer program or computer program product, wherein the computer program or computer program product includes instructions, in particular stored on a computer-readable and/or non-volatile storage medium, which, when executed by one or more computers or a system, cause the computer(s) or system to carry out a method according to claim 1.
